(19) United States
(12) Patent Application Publication
(10) Pub. No.: US 2025/0344079 A1
(43) Pub. Date: Nov. 6, 2025

(54) MANAGING A PLURALITY OF WIRELESS DEVICES THAT ARE OPERABLE TO CONNECT TO A COMMUNICATION NETWORK

(71) Applicant: Telefonaktiebolaget LM Ericsson (publ), Stockholm (SE)

(72) Inventors: Henrik RYDÉN, Stockholm (SE); Rakesh RANJAN, Järfälla (SE)

(21) Appl. No.: 18/855,407

(22) PCT Filed: Apr. 21, 2023
(86) PCT No.: PCT/EP2023/060433

§ 371 Date: Oct. 9, 2024

(30) Foreign Application Priority Data
Apr. 22, 2022 (WO) PCT/EP2022/060753

(51) Int. Cl. H04W 24/02; H04L 41/16

(52) U.S. Cl. CPC H04W 24/02; H04L 41/16

(57) ABSTRACT

A method for managing a plurality of wireless devices. The method includes obtaining a plurality of base Machine Learning (ML) models, wherein each base ML model is operable to provide an output on the basis of which at least one RAN operation performed by a wireless device may be configured. The method further includes transmitting characterising information for individual models of the plurality of base ML models and configuration information for the plurality of base ML models over the RAN. The method further includes receiving an indication of which one or more of the plurality of base ML models the wireless device will be using as an ensemble ML model in connection with a RAN operation performed by the wireless device, and setting a value of at least one configuration parameter associated with the RAN operation performed by the wireless device based on the received indication.

### TECHNICAL FIELD

The present disclosure relates to methods for managing a plurality of wireless devices that are operable to connect to a communication network, and to methods for managing a wireless device that is operable to connect to a communication network, the methods performed by a Radio Access Network (RAN) node of the communication network, and by the wireless device respectively. The present disclosure also relates to a RAN node for managing a plurality of wireless devices that are operable to connect to a communication network, a wireless device, and to a computer program product configured, when run on a computer to carry out methods for managing a plurality of wireless devices and/or for managing a wireless device.

### BACKGROUND

Machine Learning (ML) is a branch of Artificial Intelligence (AI), and refers to the use of algorithms and statistical models to perform a task. ML generally involves a training phase, in which algorithms build a computational operation based on some sample input data, and an inference phase, in which the computational operation is used to make predictions or decisions without being explicitly programmed to perform the task. Support for ML in communication networks is an ongoing challenge. The 3rd Generation Partnership Project (3GPP) has proposed a study item on “Radio Access Network (RAN) intelligence (Artificial Intelligence/Machine Learning) applicability and associated use cases (e.g. energy efficiency, RAN optimization), which is enabled by Data Collection”. It is proposed that the study item will investigate how different use cases impact the overall AI framework, including how data is stored across the different network nodes, model deployment, and model supervision.

One way to enable AI/ML technologies in 3GPP networks is via downloadable AI, the basic idea of which envisages that the network signals an ML model to the device (that is the device downloads an ML model from the network), following which the device then runs the ML model locally on its hardware (i.e., the device performs inference).

The general concept of downloadable Al was proposed in WO2022/013104.

Downloadable AI enables the network to run custom ML models on a device using data it would otherwise not have access to. For example, the network does not have access to a device's downlink channel estimates from CSI-RS. Downloadable Al allows the network to compute an ML-based channel state information (CSI) report directly from the device's channel estimates, using an ML model of the network's choice. Another benefit of downloadable Al is that the device does not need to signal the ML model's inputs to the network, as would be necessary if the network were to run the ML model, so saving network resources and avoiding potential data privacy issues. Additionally, the ML model can be executed more frequently at the device, for example, whenever the device receives new information. In some examples, downloadable AI can be viewed as an advanced device configuration, in that the network signals an advanced algorithm to the device.

ML model configuration is typically device specific, and will depend on the device Quality of Service (QOS) requirements, for example how costly a Radio Link Failure would be for a device. One device might need an accurate but large model, while for another device, a smaller but less accurate model will be sufficient. Device processing capabilities can also determine how complex a model individual devices are able to receive and execute. Even when an ML model is accurately tailored to a device's capabilities and QoS requirements, variation in device traffic and mobility may affect the cost benefit assessment for use of any individual model. For example, the achieved gain in radio network operation may be insufficient to justify the processing overhead of receiving a large model if current device traffic is small, or if the model will be outdated shortly after reception owing to high device mobility.

Tailoring of individual ML models to static and dynamic device requirements can be achieved by performing a unicast transmission to each device, the transmission containing a model that is optimal for each device at a given time. However, this unicast transmission of individually tailored models can vastly increase the resources needed for model transmissions, with associated negative impacts on the availability of such resources for other network requirements.

### SUMMARY

It is an aim of the present disclosure to provide methods, a RAN node, a wireless device, and a computer program product which at least partially address one or more of the challenges mentioned above. It is a further aim of the present disclosure to provide methods, a RAN node, a wireless device, and a computer program product which cooperate to facilitate flexible provision of suitably tailored ML models to wireless devices without incurring the costly resource requirements associated with unicast transmission.

According to a first aspect of the present disclosure, there is provided a method for managing a plurality of wireless devices that are operable to connect to a communication network, wherein the communication network comprises a Radio Access Network (RAN). The method, performed by a RAN node of the communication network, comprises obtaining a plurality of base Machine Learning (ML) models, wherein each base ML model is operable to provide an output on the basis of which at least one RAN operation performed by a wireless device may be configured, and wherein the plurality of base ML models has been trained using an ensemble training method. The method further comprises transmitting characterising information for individual models of the plurality of base ML models over the RAN, and transmitting configuration information for the plurality of base ML models over the RAN. The method further comprises receiving, from at least one wireless device, an indication of which one or more of the plurality of base ML models the wireless device will be using as an ensemble ML model in connection with a RAN operation performed by the wireless device, and setting a value of at least one configuration parameter associated with the RAN operation performed by the wireless device based on the received indication.

According to another aspect of the present disclosure, there is provided a method for managing a wireless device that is operable to connect to a communication network, wherein the communication network comprises a RAN. The method, performed by the wireless device, comprises receiving, in a transmission from a RAN node of the communication network, characterising information for a plurality of base ML models, wherein each base ML model is operable to provide an output on the basis of which at least one RAN operation performed by the wireless device may be configured, and wherein the plurality of base ML models has been trained using an ensemble training method. The method further comprises determining which one or more of the plurality of base ML models to receive from the RAN node, and receiving, in a transmission from the RAN node of the communication network, configuration information for the determined base ML models. The method further comprises transmitting to the RAN node an indication of which one or more of the plurality of base ML models the wireless device will be using as an ensemble ML model in connection with a RAN operation performed by the wireless device. The method further comprises executing the indicated base ML models as an ensemble ML model in accordance with the received configuration information, and performing a RAN operation configured on the basis of an output of the executed ensemble ML model.

According to another aspect of the present disclosure, there is provided a computer program product comprising a computer readable non-transitory medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided a RAN node of a communication network comprising a RAN, wherein the RAN node is for managing a plurality of wireless devices that are operable to connect to a communication network. The RAN node comprises processing circuitry configured to cause the RAN node to obtain a plurality of base ML models, wherein each base ML model is operable to provide an output on the basis of which at least one RAN operation performed by a wireless device may be configured, and wherein the plurality of base ML models has been trained using an ensemble training method. The processing circuitry is further configured to cause the RAN node to transmit characterising information for the plurality of base ML models over the RAN, and to transmit configuration information for the plurality of base ML models over the RAN. The processing circuitry is further configured to cause the RAN node to receive, from at least one wireless device, an indication of which one or more of the plurality of base ML models the wireless device will be using as an ensemble ML model in connection with a RAN operation performed by the wireless device, and to set a value of at least one configuration parameter associated with the RAN operation performed by the wireless device based on the received indication.

According to another aspect of the present disclosure, there is provided a wireless device that is operable to connect to a communication network, wherein the communication network comprises a RAN. The wireless device comprises processing circuitry configured to cause the wireless device to receive, in a transmission from a RAN node of the communication network, characterising information for a plurality of base ML models, wherein each base ML model is operable to provide an output on the basis of which at least one RAN operation performed by the wireless device may be configured, and wherein the plurality of base ML models has been trained using an ensemble training method. The processing circuitry is further configured to cause the wireless device to determine which one or more of the plurality of base ML models to receive from the RAN node, and to receive, in a transmission from the RAN node of the communication network, configuration information for the determined base ML models. The processing circuitry is further configured to cause the wireless device to transmit to the RAN node an indication of which one or more of the plurality of base ML models the wireless device will be using as an ensemble ML model in connection with a RAN operation performed by the wireless device, to execute the indicated base ML models as an ensemble ML model in accordance with the received configuration information, and to perform a RAN operation configured on the basis of an output of the executed ensemble ML model.

Aspects of the present disclosure thus provide methods, a RAN node and a wireless device according to which multiple base ML models may be transmitted, for example via broadcast or multicast, to a plurality of wireless devices. The base ML models are for use in connection with a RAN operation, have been trained using an ensemble based training method, such as stacking or boosting, and can be combined by the individual devices in order to improve model accuracy. Each device can select one or more of the transmitted base ML models, for example based on its QoS requirements, user behavior (traffic, mobility) and available processing capabilities. In this manner, flexibility is offered for devices to make ensemble-based predictions, balancing model performance against resource cost and capability in accordance with their own individual circumstances and needs, and without incurring the signaling overhead associated with unicasting tailored models to each device.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a computer implemented method for managing a plurality of wireless devices that are operable to connect to a communication network;

FIG. 2 is a flow chart illustrating process steps in a computer implemented method for managing a wireless device that is operable to connect to a communication network;

FIGS. 3a to 3c show flow charts illustrating another example of a method for managing a plurality of wireless devices that are operable to connect to a communication network;

FIGS. 4a and 4b show flow charts illustrating another example of a method for managing a wireless device that is operable to connect to a communication network;

FIG. 5 illustrates an example of a boosting ensemble;

FIG. 6 illustrates an implementation of a boosting ensemble;

FIG. 7 is a block diagram illustrating functional modules in an example RAN node;

FIG. 8 is a block diagram illustrating functional modules in another example RAN node;

FIG. 9 is a block diagram illustrating functional modules in an example wireless device;

FIG. 10 is a block diagram illustrating functional modules in another example wireless device;

FIG. 11 illustrates a process flow for an example implementation of the methods of FIGS. 1 to 4b;

FIG. 12 illustrates an example time/frequency resource allocation for transmitting configuration information for base ML models;

FIG. 13 illustrates an example scenario for signal quality drop prediction;

FIG. 14 illustrates an example an autoencoder for CSI compression;

FIG. 15 illustrates an example scenario for SCP;

FIGS. 16a to 16c illustrate performance of an example ensemble model; and

FIG. 17 is an example illustration of channel compression using an ensemble of encoders.

### DETAILED DESCRIPTION

A single “one fits all” ML model downloaded in a broadcasting fashion to all wireless devices in a given area would avoid the significant resource costs of individually unicasting tailored ML models to devices. However, as discussed above, the “one fits all” ML model may be inadequate for some devices and overly complex or resource intensive for others. Examples of the present disclosure propose a method to reduce signalling overhead and improve the flexibility for devices to obtain an ML model that is matched to their current requirements. This is achieved by the devices selecting which one or more base ML models they wish to receive from the network, the base ML models having been trained for enabling ensemble-based predictions.

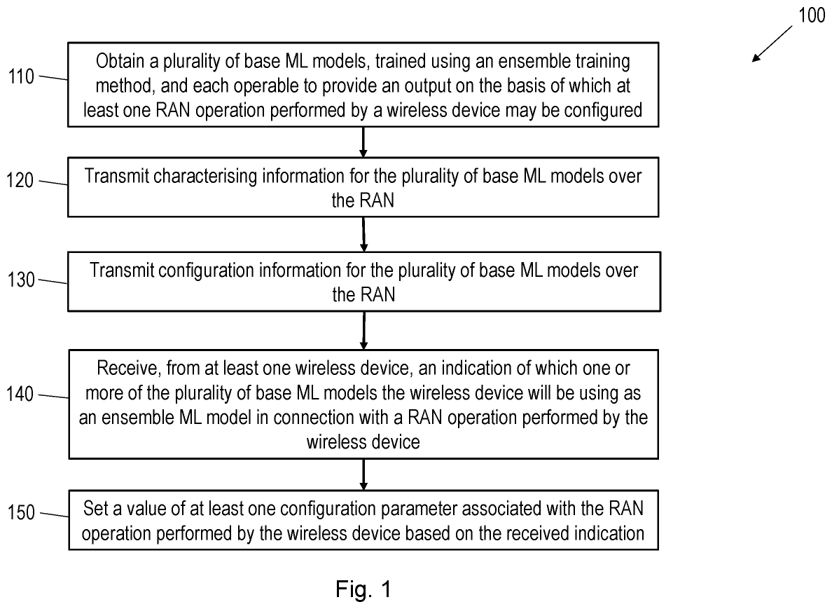

FIG. 1 is a flow chart illustrating process steps in a computer implemented method 100 for for managing a plurality of wireless devices that are operable to connect to a communication network, wherein the communication network comprises a Radio Access Network (RAN). The method is performed by a RAN node of the communication network. A RAN node of a communication network comprises a node that is operable to transmit, receive, process and/or orchestrate wireless signals. A RAN node may comprise a physical node and/or a virtualised network function. In some examples, a RAN node may comprise a NodeB, eNodeB, Master eNodeB, Secondary eNodeB, a network node belonging to a Master Cell Group (MSG) or Secondary Cell Group (SCG), base station (BS), Multi-Standard Radio (MSR) radio node such as MSR BS, eNodeB, gNodeB, network controller, Radio Network Controller (RNC), Base Station Controller (BSC), relay, donor node controlling relay, Base Transceiver Station (BTS), Access Point (AP), transmission points, transmission nodes, Remote Radio Unit (RRU), Remote Radio Head (RRH), nodes in Distributed Antenna System (DAS), etc., or any other current or future implementation of such functionality. Where the following description refers to steps taken in or by a RAN node, this also includes the possibility that some or all of the processing and/or decision making steps may be performed in a device that is physically separate from the radio antenna of the node, but is logically connected thereto. Thus, where processing and/or decision making is carried out “in the cloud”, the relevant processing device is considered to be part of the node for these purposes.

Referring to FIG. 1, in a first step 110, the method 100 comprises obtaining a plurality of base Machine Learning (ML) models, wherein each base ML model is operable to provide an output on the basis of which at least one RAN operation performed by a wireless device may be configured, and wherein the plurality of base ML models has been trained using an ensemble training method. In step 120, the method comprises transmitting characterising information for individual models of the plurality of base ML models over the RAN. The method then comprises, in step 130, transmitting configuration information for the plurality of base ML models over the RAN and, in step 140, receiving, from at least one wireless device, an indication of which one or more of the plurality of base ML models the wireless device will be using as an ensemble ML model in connection with a RAN operation performed by the wireless device. In step 150 the method the comprises setting a value of at least one configuration parameter associated with the RAN operation performed by the wireless device based on the received indication.

The method 100 thus provides, in a resource efficient manner, base ML models that can be received and combined by individual wireless devices in accordance with their specific requirements and capabilities. In this manner, each wireless device can use an ML model that is tailored to its specific balance of requirements and computational complexity without the resource intensive unicasting of specific models to specific wireless devices.

For the purposes of the present disclosure, the term “ML model” encompasses within its scope the following concepts:
machine Learning algorithms, comprising processes or instructions through which data may be used in a training process to generate a model artefact for performing a given task, or for representing a real-world process or system; and
the model artefact that is created by such a training process, and which comprises the computational architecture that performs the task.

The base ML models of the example methods disclosed herein may comprise open-format models, which may be ML models of a specified format that are mutually recognizable across vendors, and allow interoperability. Such open-format ML models may allow access to model design information when shared, in that such information is not hidden. In other examples, the base ML models of the example methods disclosed herein may comprise proprietary-format models, that are of a vendor-and/or device-specific proprietary format, such as a device specific binary executable format. Such proprietary-format models may be not mutually recognizable across vendors, and may hide model design information from other vendors when shared.

For the purposes of the present disclosure, ensemble training is a Machine Learning process in which multiple ML models, referred to in the present disclosure as base ML models, are trained to solve the same problem, and combined to obtain improved results when compared with those achieved by any one individual base ML model. The aim of ensemble training is to refine the individual base ML models and determine a combination of the base ML models, referred to as an ensemble ML model, that is more accurate and/or more robust than the individual base ML models. Examples of ensemble training methods include Stacking, Bootstrap Aggregating (Bagging), Boosting, Bucket of Models, Bayesian Model Averaging, etc.

Also for the purposes of the present disclosure, a RAN operation may comprise any operation that is at least partially performed by the wireless device in the context of its connection to the Radio Access Network. For example, a RAN operation may comprise a connection operation, a mobility operation, a reporting operation, a resource configuration operation, a synchronisation operation, a traffic management operation etc. Specific examples of RAN operations may include Handover, secondary carrier prediction, geolocation, signal quality prediction, beam measurement and beamforming, traffic prediction, Uplink synchronisation, channel state information compression, wireless signal reception/transmission, etc. Any one of more of these example operations or operation types may be configured on the basis of an output of an ML model.

For example, the ML model may predict certain measurements, on the basis of which decisions for RAN operations may be taken. Such measurements may be used by the wireless device and/or provided to the RAN node performing the method. In further examples, the timing or triggering of a RAN operation may be based upon a prediction output by an ML model.

The configuration parameter associated with the RAN operation, a value for which is set by the RAN node in step 150 of the method 100, may relate to the how the operation is performed by the wireless device, how the operation performed by the wireless device is managed at the RAN node, how information reported in connection with the operation is processed, etc. The configuration parameter may be associated with the RAN operation in that it is a configuration parameter for the RAN operation itself, or that it is a configuration parameter for triggering the RAN operation, for reporting information relating to the RAN operation (such as operation outcome), or for processing an outcome of the RAN operation at the RAN node. For example, the configuration parameter may be a level for triggering the RAN operation, or a reporting timing parameter, or a confidence level for a reliability of the outcome of the RAN operation or for an outcome of the ML model on the basis of which the RAN operation is configured by the wireless device, etc. The configuration parameter may for example be a parameter of the wireless device or of the RAN node. The value of the configuration parameter may be sent to the wireless device after being set in accordance with step 150 of the method.

The method 100 may be complemented by a method 200 performed by a wireless device.

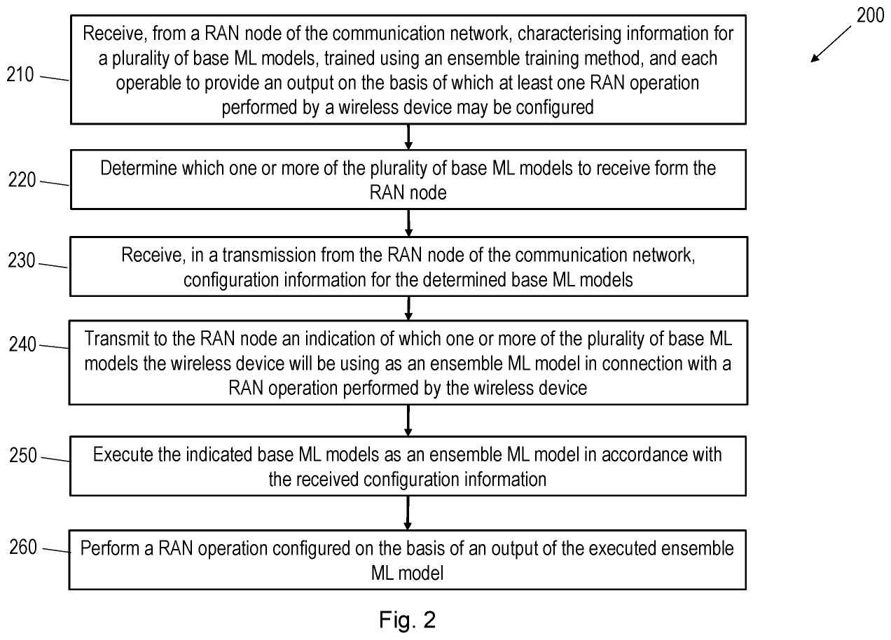

FIG. 2 is a flow chart illustrating process steps in a method 200 for managing a wireless device that is operable to connect to a communication network, wherein the communication network comprises a RAN. The method is performed by a wireless device, which comprises a device capable, configured, arranged and/or operable to communicate wirelessly with network nodes and/or other wireless devices. Examples of a wireless device include, but are not limited to, a smart phone, mobile phone, cell phone, voice over IP (VoIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

Referring to FIG. 2, the method 200 comprises, in a first step 210, receiving, in a transmission from a RAN node of the communication network, characterising information for a plurality of base ML models. Each base ML model is operable to provide an output on the basis of which at least one RAN operation performed by the wireless device may be configured, and the plurality of base ML models has been trained using an ensemble training method. In step 220, the method 200 comprises determining which one or more of the plurality of base ML models to receive from the RAN node. The method 200 then corpses receiving, in a transmission from the RAN node of the communication network, configuration information for the determined base ML models at step 230, and transmitting to the RAN node an indication of which one or more of the plurality of base ML models the wireless device will be using as an ensemble ML model in connection with a RAN operation performed by the wireless device, in step 240. In step 250, the method 200 comprises executing the indicated base ML models as an ensemble ML model in accordance with the received configuration information. The method 200 then comprises performing a RAN operation configured on the basis of an output of the executed ensemble ML model in step 260.

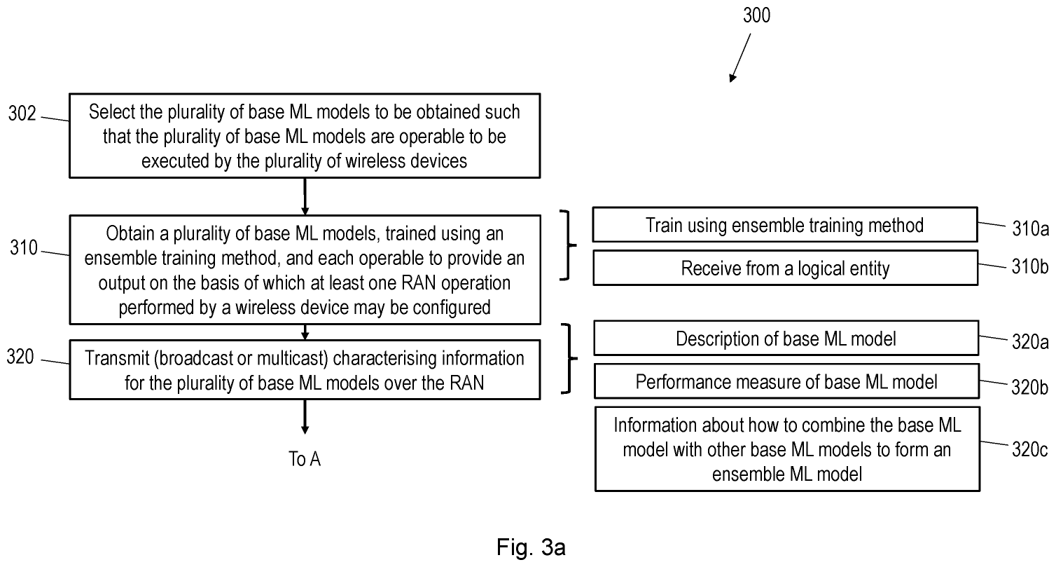

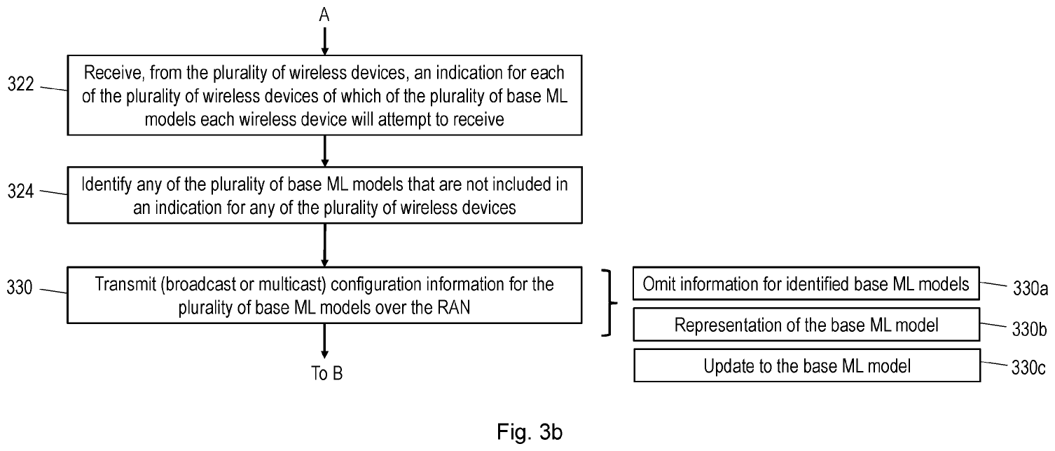

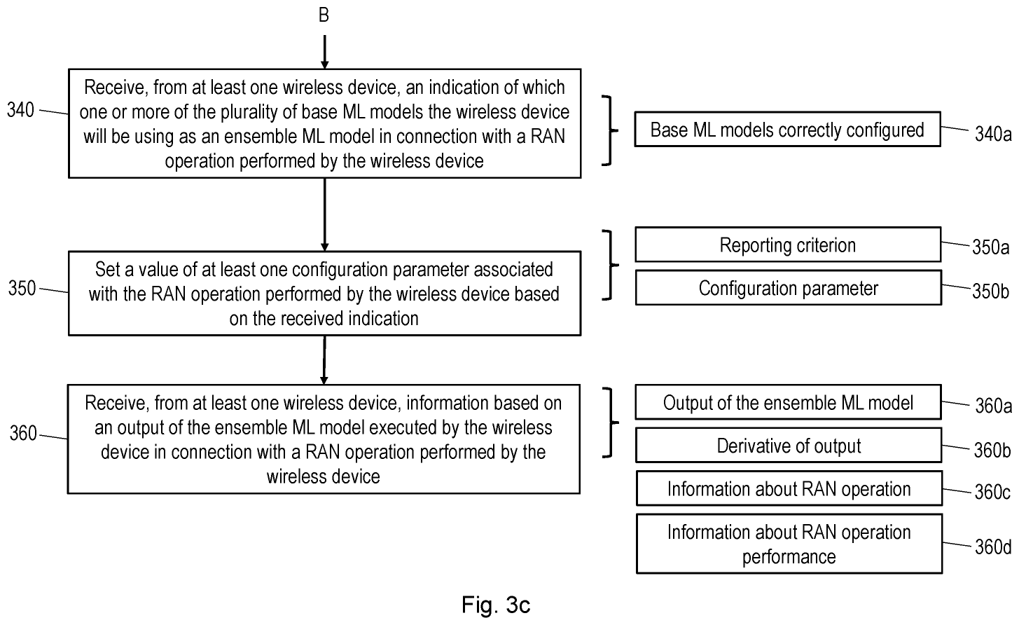

FIGS. 3a to 3c show flow charts illustrating another example of a method 300 managing a plurality of wireless devices that are operable to connect to a communication network, wherein the communication network comprises a Radio Access Network (RAN). The method 300 is performed by a RAN node of the communication network, which comprises a node that is operable to transmit, receive, process and/or orchestrate wireless signals, as discussed in greater detail above with reference to the method 100. The method 300 illustrates examples of how the steps of the method 100 may be implemented and/or supplemented to provide the above discussed and additional functionality.

Referring initially to FIG. 3a, in a first step 302, the RAN node selects a plurality of base ML models to be obtained in a subsequent step. The plurality of base ML models is selected at step 302 such that each of the plurality of base ML models is operable to be executed by the plurality of wireless devices. In some examples of the present disclosure, the RAN node may be supporting specific pluralities of wireless devices, such as IoT devices or smartphones associated with human users. These different pluralities may have very different computational, connectivity and memory resources, and so the RAN node may ensure the plurality of base ML models is appropriate for the specific plurality of wireless devices to which they will be broadcast or multicast in a later method step. For example, for IoT devices, the RAN node may obtain a large number of base ML models, each of which is relatively small. For smartphones, a smaller set of more complex base ML models may be appropriate. The RAN node may select the base ML models from a memory or other repository in which details of base ML models which may be obtained by the RAN node are stored. Such a repository may be located within the RAN node or accessible to the RAN node, for example in a cloud based location.

In step 310, the RAN node obtains a plurality of base ML models, wherein each base ML model is operable to provide an output on the basis of which at least one RAN operation performed by a wireless device may be configured, and wherein the plurality of base ML models has been trained using an ensemble training method. As illustrated in FIG. 3a, this may comprise training the plurality of base ML models using an ensemble training method in step 310a, or receiving the plurality of base ML models in step 310b from a logical entity responsible for training the plurality of base ML models. The logical entity could be another RAN node, for example in the case of sharing of base ML models amongst a cluster of RAN nodes with similar radio or physical conditions, meaning that trained models are applicable for conditions across the cluster. Alternatively, the logical entity could be a centralised location such as a cloud location, with the ensemble training being performed in the cloud and the base models being provided to the RAN node. As discussed in greater detail above with reference to the method 100, an ensemble training method comprises a Machine Learning process in which multiple “base” ML models are trained to solve the same problem, and combined to obtain improved results when compared with those achieved by any one individual base ML model. Examples of ensemble training methods include Stacking, Bootstrap Aggregating (Bagging), Boosting, Bucket of Models, Bayesian Model Averaging, etc.

In step 320 of the method 300, the RAN node transmits characterising information for individual models of the plurality of base ML models over the RAN. This may comprise sending at least one of a broadcast transmission or a multicast transmission of the configuration information. A broadcast transmission may have the advantage of reducing to a minimum the signalling overhead associated with transmitting the characterising information to the plurality of wireless devices. However, in some situations, it may be envisaged that particular base ML models may be adapted or suited to particular wireless devices. For example, only a certain subset of base ML models may be compatible with a certain device type (IoT device, smartphone etc), or with devices of a certain chipset vendor, etc. In these situations, it may be desirable to multicast such specific base ML models to the particular plurality of wireless devices to which they are suited.

As illustrated in FIG. 3a, the characterising information for a base ML model may comprise at least one of a description of the base ML model (illustrated at 320a), a performance measure of the base ML model (illustrated at 320b), and/or information about how to combine the base ML model with other base ML models to form an ensemble ML model (illustrated at 320c). In some examples, a description of a base ML model may include model size (number of bytes), type of model, required input features, any non-radio type of input, etc. A performance measure of a base ML model may comprise Mean Squared Error (MSE), Log-loss, the area under the receiver operating characteristic curve (AUC-ROC), etc., and may include use case specific Key Performance Indicators (KPIs), such as precision/recall in detecting radio-link failures, precision/recall in predicting best frequency and beam, etc. The information about how to combine the base ML model with other base ML models may comprise ensemble weights, and may also include an importance weighting for each base ML model with respect to the combined ensemble model. All of this characterising information may assist with selection by wireless devices of which base ML model(s) to receive, as discussed in further detail below with reference to method 400 performed by a wireless device.

Referring now to FIG. 3b, following transmission of the characterising information, in step 322 the RAN node may receive, from the plurality of wireless devices, an indication for each of the plurality of wireless devices of which of the plurality of base ML models each wireless device will attempt to receive. The indication may comprise for example an identification of the one or more base ML models that the relevant wireless device will attempt to receive. The identification may comprise any process or method for identifying a base ML model in a manner allowing for a common understanding between the RAN node and the UE. The process or method for base ML model identification may or may not be applicable, and information regarding the base ML model may be shared during model identification. Following step 322, the RAN node may then identify any of the plurality of base ML models that are not included in an indication for any of the plurality of wireless devices at step 324.

In step 330, the RAN node transmits configuration information for the plurality of base ML models over the RAN. As for the transmission of characterising information in step 320, this may comprise sending at least one of a broadcast transmission or a multicast transmission of the configuration information. As illustrated at 330a, the RAN node may omit from the transmission of configuration information for the plurality of base ML models, configuration information for any base ML model identified at step 324. This avoids transmitting configuration information that none of the plurality of wireless devices is intending to receive, so saving resources.

As illustrated at 330b and 330c, the configuration information for a base ML model may comprise at least one of a representation of the base ML model or an update to the base ML model. For the purposes of the present disclosure, it will be appreciated that the configuration information provides sufficient information for a wireless device receiving the configuration information to be able to run the base ML model. A representation of a base ML model may for example include details of the architecture of the model and values for its trainable parameters, for example number of hidden layers in a Deep Neural Network (DNN), number of neurons per layer and trainable weights. A representation of an ML model may be transmitted by the RAN node for example using any existing model format such as Open Neural Network Exchange, ONNX (https://onnx.ai), or formats used in commonly used toolboxes such as Keras or PyTorch. An update to the base ML model may comprise for example a model update and/or a model parameter update. A model update may comprise a process for updating the model parameters and/or the structure of a model. A model parameter update may comprise a process for updating the model parameters of a model. Information about how to combine the base ML models into the ensemble ML model may be transmitted as part of the model description in the characterising information (as discussed above), or as part of the configuration information.

Referring now to FIG. 3c, in step 340, the RAN node receives, from at least one wireless device, an indication of which one or more of the plurality of base ML models the wireless device will be using as an ensemble ML model in connection with a RAN operation performed by the wireless device. In some examples, as illustrated at 340a, this may comprise an indication of the one or more base ML models that the wireless device was able to configure correctly using the transmitted configuration information. It will be appreciated that in some circumstances, the correctly received base ML models may be different to those that the wireless device intended to use (and which may have been included in an indication received by the RAN node in step 322), for example if the wireless device was unable to receive configuration information correctly for one or more base ML models it had intended to use, or was for some reason unable to run a base ML model for which configuration information was at least partially received. As for the indication which may be received in step 322, the indication received in step 340 may comprise for example an identification of the one or more base ML models that the relevant wireless device will be using as an ensemble ML model. The identification may comprise any process or method for identifying a base ML model in a manner allowing for a common understanding between the RAN node and the UE. The process or method for base ML model identification may or may not be applicable, and information regarding the base ML model may be shared during model identification.

In step 350, the RAN node sets a value of at least one configuration parameter associated with the RAN operation performed by the wireless device based on the received indication. As illustrated at 350a and 350b, the at least one configuration parameter associated with the RAN operation performed by the wireless device may comprise at least one of a reporting criterion for reporting of information relating to an output of the ensemble ML model executed by the wireless device, and/or a parameter relating to configuration, on the basis of an output of the ensemble ML model, of the RAN operation performed by the wireless device. The parameter relating to configuration, on the basis of an output of the ensemble ML model, of the RAN operation performed by the wireless device may be a parameter relating to wireless device activities for the RAN operation or a parameter relating to RAN node activities for the RAN operation performed by the wireless device. For example, in the case of Secondary Carrier Prediction (SCP), the RAN node may set a parameter determining whether predictions from the ensemble ML model should be verified with inter-frequency measurements or not, before preparing a dual connectivity for the device. In setting the parameter value at step 350, the RAN node thus takes action as a consequence of the information received about which of the base ML models a given wireless device will be using as an ensemble model in connection with the RAN operation. With setting this parameter, the RAN node may tailor actions of the wireless device and/or its own actions to reflect the reliability, accuracy, or other characteristic(s) of the output of the ensemble method, which will be used by the wireless device in connection with the RAN operation. This may involve the RAN node requesting more or less frequent reporting as part of or associated with the RAN operation, requiring or dispensing with additional checks of predicted values, configuring the RAN operation as a consequence of the reliability, accuracy or other characteristic(s) of the ensemble method, etc. Depending on the nature of the parameter, the RAN node may additionally transmit the parameter to the wireless device (for example if the parameter is to tailor actions of the wireless device).

In step 360, the RAN node may additionally receive, from at least one wireless device, information based on an output of the ensemble ML model executed by the wireless device in connection with a RAN operation performed by the wireless device. As illustrated at 360a to 360d, the information based on an output of the ensemble ML model may comprise any one or more of an output of the ensemble ML model (360a), a derivative of an output of the ensemble ML model, (360b), information relating to a RAN operation performed by the wireless device and configured on the basis of an output of the ensemble ML model, (360c), and/or information relating to performance of a RAN operation that has been configured on the basis of an output of the ML model (360d).

In some examples, the RAN node may receive an error message from the wireless device if the wireless device was unable to execute the ensemble ML model correctly, or if the ensemble ML model failed to provide a useable output, or an output within expected limitations.

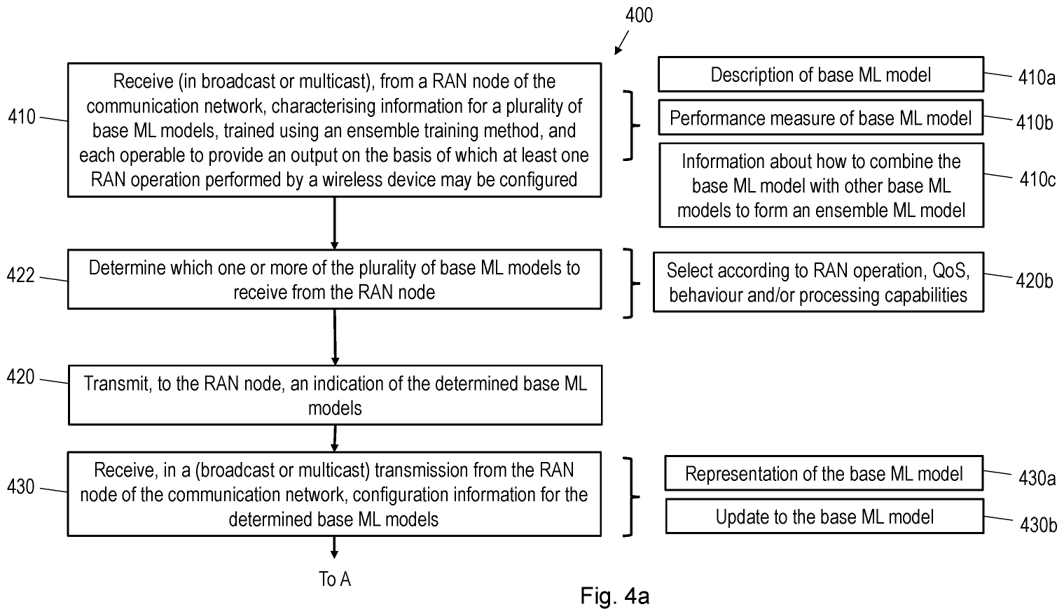

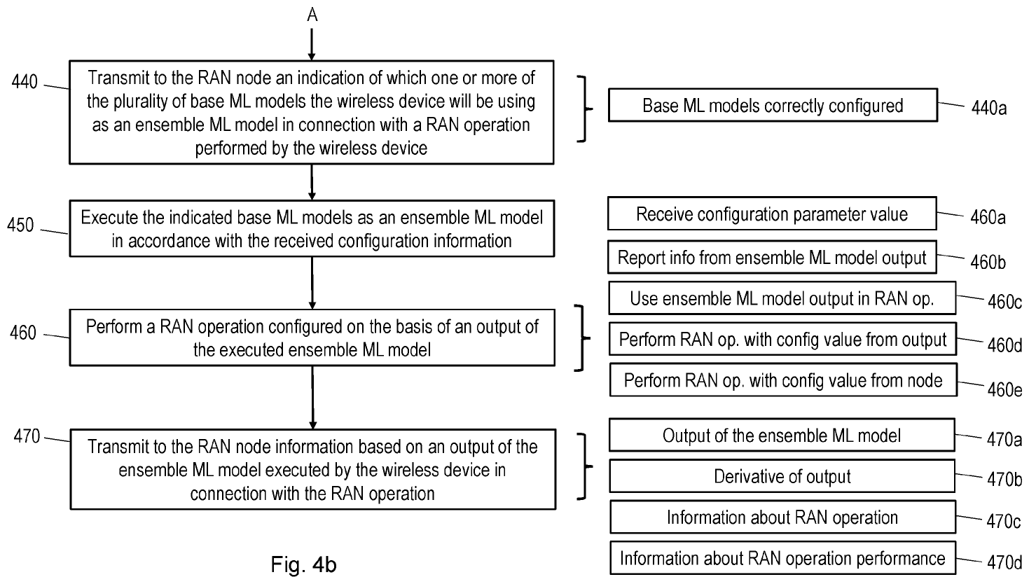

FIGS. 4a and 4b show flow charts illustrating another example of a method 400 for managing a wireless device that is operable to connect to a communication network, wherein the communication network comprises a RAN. As for the method 200 discussed above, the method 400 is performed by the wireless device. The method 400 illustrates examples of how the steps of the method 200 may be implemented and/or supplemented to provide the above discussed and additional functionality.

Referring initially to FIG. 4a, in step 410, the wireless device receives, in a transmission from a RAN node of the communication network, characterising information for a plurality of base ML models, wherein each base ML model is operable to provide an output on the basis of which at least one RAN operation performed by the wireless device may be configured, and wherein the plurality of base ML models has been trained using an ensemble training method. As illustrated in FIG. 4a, the characterising information may be received by the wireless device in at least one of a broadcast transmission or a multicast transmission of the configuration information.

As discussed above with reference to the method 300, the characterising information for a base ML model may comprise at least one of a description of the base ML model (as illustrated at 410a), a performance measure of the base ML model (as illustrated at 410b) and/or information about how to combine the base ML model with other base ML models to form an ensemble ML model (as illustrated at 410c).

In step 420, the wireless device determines which one or more of the plurality of base ML models to receive from the RAN node. As illustrated at 420b, this may comprise selecting base ML models from among the plurality of base ML models according to at least one of the RAN operation to be configured on the basis of an output of the executed ensemble ML model, a Quality of Service requirement for the wireless device, a behaviour of the wireless device, processing capabilities of the wireless device and/or energy information for the wireless device. For example, it will be appreciated that certain base ML models may be specific to a given RAN operation. In another example, a QoS requirement for the wireless device may determine a minimum level of reliability to be achieved by the ensemble model, so dictating the choice of how many and which base ML models to receive. The behaviour of the wireless device, according to which the wireless device may determine which base ML model(s) to receive, may relate to traffic, including current or projected traffic to/from the wireless device, or its mobility. For example, a device experiencing heavy traffic may balance resource requirements to receive multiple base ML models of different sizes against quality requirements in a different manner to a device experiencing low traffic. In another example, if a device is moving relatively quickly though the radio landscape, then the received base ML models may quickly become out of date, owing to changing radio conditions as the device moves through the coverage areas of different RAN nodes. In such circumstances, the overhead of receiving multiple large base ML models may not be justified given the short time for which they will be valid for the device. Processing capabilities and available energy may also constrain the selection as to which base ML models the device is able to execute, or can afford to receive. For example, if the device battery level is low, it might not be able to afford the extra energy spent on downloading a large number of base ML models, as there will be an overhead in first receiving the base ML models before observing benefits of using the base ML models as an ensemble ML model to improve a RAN operation.

After determining which one or more of the plurality of base ML models to receive from the RAN node, the wireless device may transmit, to the RAN node, an indication of the determined base ML models in step 422. In step 430, the wireless device then receives, in a transmission from the RAN node of the communication network, configuration information for the determined base ML models. As illustrated at 430a and 430b, and discussed in greater detail above, the configuration information for a base ML model may comprise at least one of a representation of the base ML model or an update to the base ML model.

Referring now to FIG. 4b, in step 440, the wireless device transmits to the RAN node an indication of which one or more of the plurality of base ML models the wireless device will be using as an ensemble ML model in connection with a RAN operation performed by the wireless device. As illustrated at step 440a, this may comprise an indication of the one or more base ML models that the wireless device is able to configure correctly using the transmitted configuration information. In will be appreciated that in some circumstances, the correctly received base ML models may be different to those that the wireless device intended to use (an indication of which may have been transmitted by the RAN node in step 422), for example if the wireless device was unable to receive configuration information correctly for one or more base ML models, or was for some reason unable to run a base ML model for which configuration information was at least partially received.

In step 450, the wireless device executes the indicated base ML models as an ensemble ML model in accordance with the received configuration information. As discussed above, a wide range of possibilities exists for the execution of a plurality of base ML models as an ensemble ML model. These possibilities include for example majority voting, weighted voting, simple averaging, weighted averaging, Stacking, Bootstrap Aggregating (Bagging), Boosting, Bucket of Models, Bayesian Model Averaging, etc. In executing the indicated base ML models as an ensemble ML model in accordance with the received configuration information, the wireless device may make use of information about how to combine the base ML models with other base ML models. As discussed above, such combination information may be provided by the RAN node in either or both of the characterising information or the configuration information, received by the wireless device at steps 410 and 430. The combination information may for example comprise ensemble weights, and/or an importance weighting for each base ML model with respect to the combined ensemble model. Following execution of the ensemble ML model, the wireless device then, in step 460, performs a RAN operation configured on the basis of an output of the executed ensemble ML model. As illustrated at step 460a, this may comprise receiving from the RAN node a value of at least one configuration parameter associated with the RAN operation. This value may be the value set by the RAN node on the basis of the received indication of which base ML models the wireless device will be using in step 350 of the method 300.

Performing a RAN operation configured on the basis of an output of the executed ensemble ML model may be carried out in a range of different ways, as illustrated in FIG. 4b. For example, performing a RAN operation configured on the basis of an output of the executed ensemble ML model may comprise at least one of:
reporting information relating to an output of the ensemble ML model executed by the wireless device in accordance with a value of a configuration parameter received from the RAN node (460b),
using an output of the ensemble ML model in performing the RAN operation (460c)
performing the RAN operation in accordance with a value of a configuration parameter set on the basis of an output of the ensemble ML model (460d)
performing the RAN operation in accordance with a value of a configuration parameter received from the RAN node (460e).

In step 470, the wireless device may then transmit to the RAN node information based on an output of the ensemble ML model executed by the wireless device in connection with the RAN operation. As illustrated at 470a to 470d, this information may comprise any one or more of:
an output of the ensemble ML model,
a derivative of an output of the ensemble ML model,
information relating to a RAN operation performed by the wireless device and configured on the basis of an output of the ensemble ML model, and/or
information relating to performance of a RAN operation that has been configured on the basis of an output of the ML model.

In some examples, if the wireless device is unable to execute the ensemble ML model correctly, or if the ensemble ML model fails to provide a useable output, or an output within expected limitations, then the wireless device may send an error message to the RAN node.

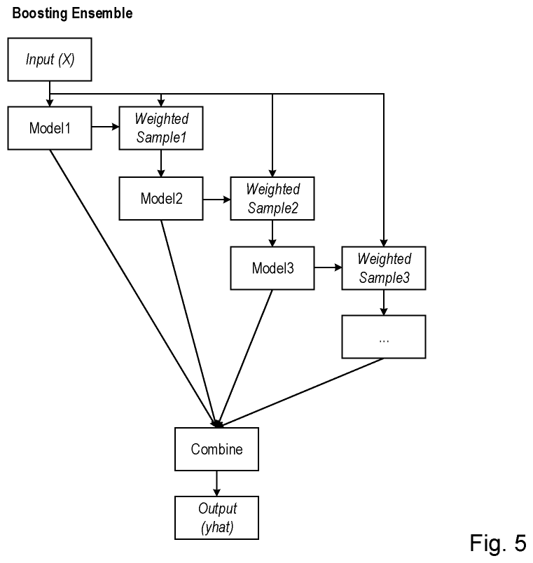

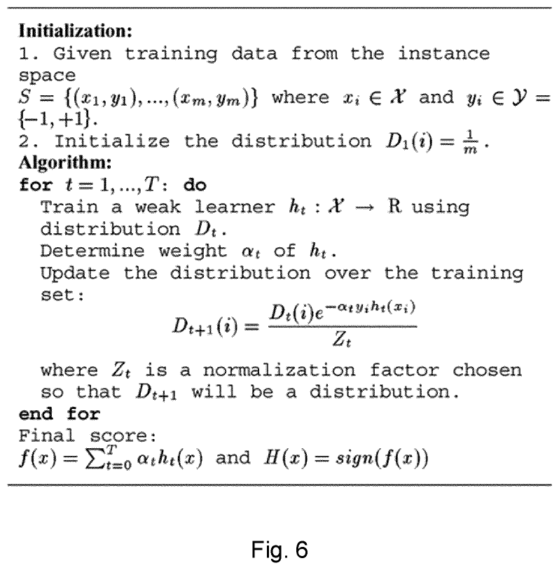

It will be appreciated that the methods 100, 200, 300 and 400 described above all make reference to a plurality of base ML models that have been trained using an ensemble training method. As discussed above, such methods seek to refine individual base ML models and determine a combination of the base ML models, referred to as an ensemble ML model, that is more accurate and/or more robust than the individual base ML models. Examples of ensemble training methods include Stacking, Bootstrap Aggregating (Bagging), Boosting, Bucket of Models, Bayesian Model Averaging, etc. FIGS. 5 and 6 illustrate in greater detail the Boosting ensemble method, as an example of an ensemble training method that may be appropriate for the plurality of base ML models referred to in the methods 100 to 400.

Boosting is an ensemble method that seeks to change the training data so as to focus attention on examples that models which have previously been trained on the training dataset have gotten wrong, so improving the performance of trained data models on the training set. FIG. 5, from https://machinelearningmastery.com/tour-of-ensemble-learning-algorithms/shows a boosting example in which sample weights are altered based on the prediction outcome from a certain model. An example model implementation is illustrated in FIG. 6, from U. Guz, S. Cuendet, D. Hakkani-Tur and G. Tur, “Multi-View Semi-Supervised Learning for Dialog Act Segmentation of Speech,” in IEEE Transactions on Audio, Speech, and Language Processing, vol. 18, no. 2, pp. 320-329, February 2010, doi: 10.1109/TASL.2009.2028371.

As discussed above, the methods 100 and 300 may be performed by a RAN node, and the present disclosure provides a RAN node that is adapted to perform any or all of the steps of the above discussed methods. The RAN node may comprise a physical node such as a computing device, server etc., or may comprise a virtual node. A virtual node may comprise any logical entity, such as a Virtualized Network Function (VNF) which may be instantiated in a physical or virtual server in a centralised, cloud, edge cloud or fog deployment.

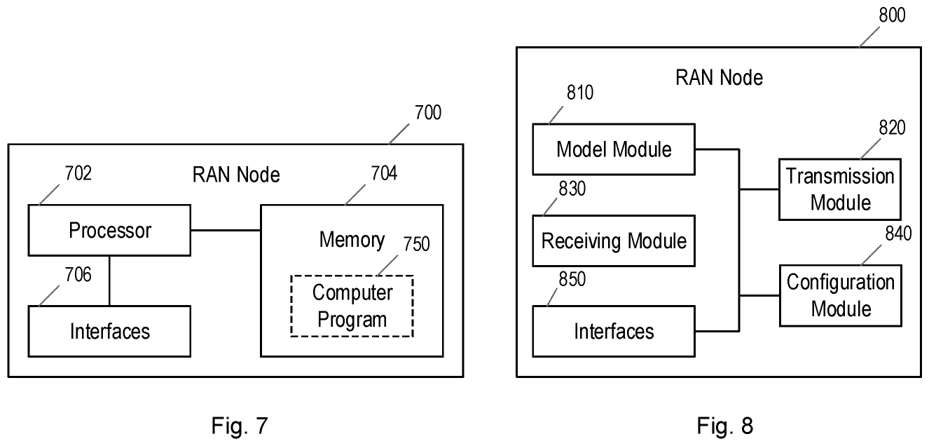

FIG. 7 is a block diagram illustrating an example RAN node 700 which may implement the method 100 and/or 300, as illustrated in FIGS. 1 and 3a to 3c, according to examples of the present disclosure, for example on receipt of suitable instructions from a computer program 750. Referring to FIG. 7 the RAN node 700 comprises a processor or processing circuitry 702, and may comprise a memory 704 and interfaces 706. The processing circuitry 702 is operable to perform some or all of the steps of the method 100 and/or 300 as discussed above with reference to FIGS. 1 and 3a to 3c. The memory 704 may contain instructions executable by the processing circuitry 702 such that the RAN node 700 is operable to perform some or all of the steps of the method 100 and/or 300, as illustrated in FIGS. 1 and 3a to 3c. The instructions may also include instructions for executing one or more telecommunications and/or data communications protocols. The instructions may be stored in the form of the computer program 750. In some examples, the processor or processing circuitry 702 may include one or more microprocessors or microcontrollers, as well as other digital hardware, which may include digital signal processors (DSPs), special-purpose digital logic, etc. The processor or processing circuitry 702 may be implemented by any type of integrated circuit, such as an Application Specific Integrated Circuit (ASIC), Field Programmable Gate Array (FPGA) etc. The memory 704 may include one or several types of memory suitable for the processor, such as read-only memory (ROM), random-access memory, cache memory, flash memory devices, optical storage devices, solid state disk, hard disk drive, etc.

FIG. 8 illustrates functional modules in another example of RAN node 800 which may execute examples of the methods 100 and/or 300 of the present disclosure, for example according to computer readable instructions received from a computer program. It will be understood that the sub-modules illustrated in FIG. 8 are functional modules, and may be realized in any appropriate combination of hardware and/or software. The modules may comprise one or more processors and may be integrated to any degree.

Referring to FIG. 8, the RAN node 800 is for managing a plurality of wireless devices that are operable to connect to a communication network. The RAN node 800 comprises a model module 810 for obtaining a plurality of base ML models, wherein each base ML model is operable to provide an output on the basis of which at least one RAN operation performed by a wireless device may be configured, and wherein the plurality of base ML models has been trained using an ensemble training method. The RAN node 800 further comprises a transmission module 820 for transmitting characterising information for the plurality of base ML models over the RAN, and for transmitting configuration information for the plurality of base ML models over the RAN. The RAN node 800 further comprises a receiving module 860 for receiving, from at least one wireless device, an indication of which one or more of the plurality of base ML models the wireless device will be using as an ensemble ML model in connection with a RAN operation performed by the wireless device. The RAN node 800 further comprises a configuration module 840 for setting a value of at least one configuration parameter associated with the RAN operation performed by the wireless device based on the received indication. The RAN node 800 may further comprise interfaces 850, which may be operable to facilitate communication with a wireless device, and/or with other nodes or modules, over suitable communication channels.

As discussed above, the methods 200 and 400 may be performed by a wireless device, and the present disclosure provides a wireless device that is adapted to perform any or all of the steps of the above discussed methods.

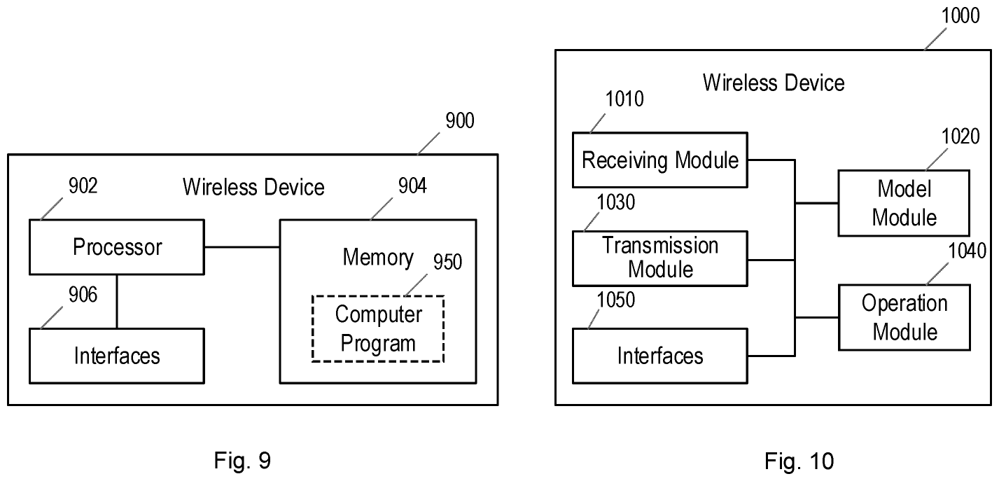

FIG. 9 is a block diagram illustrating an example wireless device 900 which may implement the method 200 and/or 400, as illustrated in FIGS. 2 and 4a and 4b, according to examples of the present disclosure, for example on receipt of suitable instructions from a computer program 950. Referring to FIG. 9, the wireless device 900 comprises a processor or processing circuitry 902, and may comprise a memory 904 and interfaces 906. The processing circuitry 902 is operable to perform some or all of the steps of the method 200 and/or 400 as discussed above with reference to FIGS. 2 and 4a and 4b. The memory 904 may contain instructions executable by the processing circuitry 902 such that the wireless device 900 is operable to perform some or all of the steps of the method 200 and/or 400, as illustrated in FIGS. 2 and 4a and 4b. The instructions may also include instructions for executing one or more telecommunications and/or data communications protocols. The instructions may be stored in the form of the computer program 950. In some examples, the processor or processing circuitry 902 may include one or more microprocessors or microcontrollers, as well as other digital hardware, which may include digital signal processors (DSPs), special-purpose digital logic, etc. The processor or processing circuitry 902 may be implemented by any type of integrated circuit, such as an Application Specific Integrated Circuit (ASIC), Field Programmable Gate Array (FPGA) etc. The memory 904 may include one or several types of memory suitable for the processor, such as read-only memory (ROM), random-access memory, cache memory, flash memory devices, optical storage devices, solid state disk, hard disk drive, etc.

FIG. 10 illustrates functional modules in another example of wireless device 1000 which may execute examples of the methods 200 and/or 400 of the present disclosure, for example according to computer readable instructions received from a computer program. It will be understood that the modules illustrated in FIG. 10 are functional modules, and may be realized in any appropriate combination of hardware and/or software. The modules may comprise one or more processors and may be integrated to any degree.

Referring to FIG. 10, the wireless device 1000 is operable to connect to a communication network, wherein the communication network comprises a RAN. The wireless device 1000 comprises a receiving module 1010 for receiving, in a transmission from a RAN node of the communication network, characterising information for a plurality of base ML models, wherein each base ML model is operable to provide an output on the basis of which at least one RAN operation performed by the wireless device may be configured, and wherein the plurality of base ML models has been trained using an ensemble training method. The wireless device 1000 further comprises a model module 1020 for determining which one or more of the plurality of base ML models to receive from the RAN node. The receiving module 101 is also for receiving, in a transmission from the RAN node of the communication network, configuration information for the determined base ML models. The wireless device 1000 further comprises a transmission module 1030 for transmitting to the RAN node an indication of which one or more of the plurality of base ML models the wireless device will be using as an ensemble ML model in connection with a RAN operation performed by the wireless device. The model module 1020 is also for executing the indicated base ML models as an ensemble ML model in accordance with the received configuration information. The wireless device 1000 further comprises an operation module 1040 for performing a RAN operation configured on the basis of an output of the executed ensemble ML model. The wireless device 1000 may further comprise interfaces 1050, which may be operable to facilitate communication with a RAN node, and/or with other devices, nodes or modules, over suitable communication channels.

FIGS. 1 to 4b discussed above provide an overview of methods which may be performed according to different examples of the present disclosure. These methods may be performed by a RAN node and a wireless device respectively, as illustrated in FIGS. 7 to 10. The methods enable the provision of a flexible number of base ML models to a plurality of wireless devices, the base ML models having been trained using an ensemble training method, such that they can be combined by the wireless devices to be run as an ensemble ML model of greater or lesser complexity, reliability and accuracy, depending on the particular models that individual wireless devices choose to receive. There now follows a detailed discussion of how different process steps illustrated in FIGS. 1 to 4b and discussed above may be implemented. The functionality and implementation detail described below is discussed with reference to the modules of FIGS. 7 to 10 performing examples of the methods 100, 200, 300 and/or 400, substantially as described above.

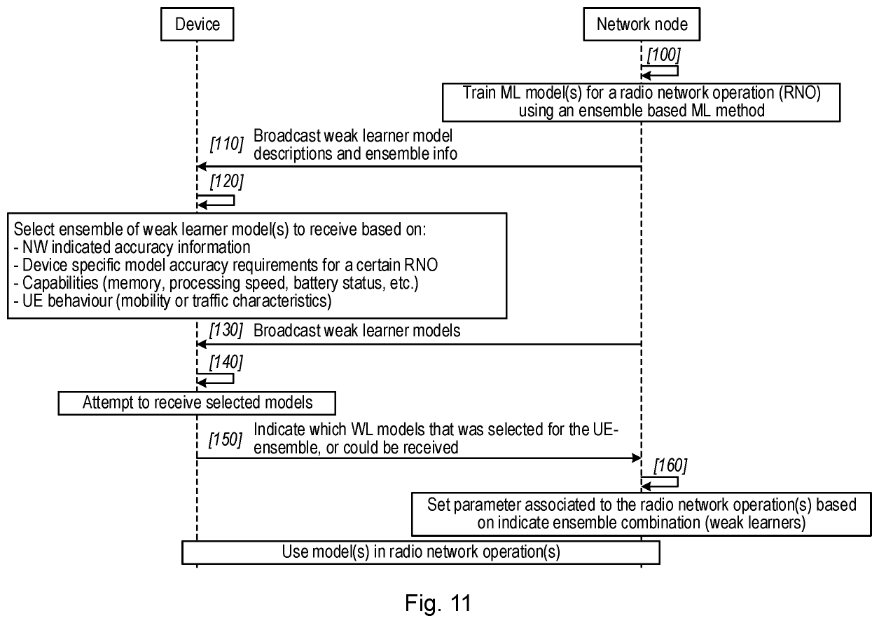

FIG. 11 illustrates a process flow for an example implementation of the methods 100, 200, 300 and/or 400. Referring to FIG. 11, the process flow is between a network node, which is an example implementation of the RAN node that performs the methods 100, 300, and a device, which is an example implementation of the wireless device that performs the methods 200, 400. In a first step 100, the network node trains base ML models for a RAN operation using an ensemble method, implementing step 110 of method 100. The network node then broadcasts descriptions and ensemble information for the base ML models (weak learners), implementing step 120 of the method 100. This broadcast is received by the device, implementing step 210 of method 200. In step 120, the device then selects which of the base ML models (weak learners) to receive according to various criteria as illustrated in the Figure, implementing step 220 of method 200. The network node then broadcasts the base ML models in step 130, implementing step 130 of the method 100. The device attempts to receive the selected models in step 140, implementing step 230 of the method 200. In step 150, the device indicates which base ML models it will use in the ensemble model, implementing step 240 of method 200 and step 140 of method 100. The network node then, in step 160 sets a parameter associated with the RAN operation based on the indication of base ML models received from the device, implementing step 150 of method 100.

Implementation of individual steps of the methods 100, 200, 300 and 400 is discussed in greater detail below.

### Model Training (Step 110 of Method 100)

The ensemble training may take place at the RAN node performing the method 100, 200 or at another location, to be provided to the RAN node performing the method. The ensemble training may train many small models (in terms of bytes), or fewer larger models. The decision as to how many models to train and of what size may be guided by the capabilities of wireless devices that are expected to be supported. For example, IoT devices may require a large number of smaller models, where smartphones can handle a smaller set of larger, more complex models. The base ML models themselves may be of any type adapted to the task they are to perform, and may for example comprise neural networks, decision trees, logistic regression etc.

It will be appreciated that different combinations of base ML model storage location, training location, and delivery format may be envisaged. Some example combinations are set out below.
Base ML model delivery (if needed) over-the-top, with model storage outside the communication network, and training at the wireless device, at the RAN node or other communication network node, and/or at a neutral site.
Base ML model delivery in proprietary format, with model storage inside the communication network, and training at the wireless device, and/or at a neutral site.
Base ML model delivery in proprietary format, with model storage inside the communication network, and training at the RAN node or other communication network node.
Base ML model delivery in open format, with model storage inside the communication network, and training at the wireless device, and/or at a neutral site.
Base ML model delivery in open format of a known model structure at the wireless device, with model storage inside the communication network, and training at the RAN node or other communication network node.
Base ML model delivery in open format of an unknown model structure at the wireless device, with model storage inside the communication network, and training at the RAN node or other communication network node.

### Transmission of Base ML Model Characteristic Information and Configuration Information (Steps 120 and 130 of Method 100)

As discussed above, the ensemble information for the base ML models, indicating how to combine the base ML models into an ensemble model, may be transmitted with the characterizing information (step 120) or with the configuration information (step 130) for the base ML models.

The characterizing information may include the accuracy for each base ML model, which may be expressed using any one or more of: MSE, Log-loss, Roc-AUC, and/or use case specific KPIs including precision/recall in detecting radio-link failures, precision/recall in predict best frequency and beam, etc.

The characterizing information may also include model size and other parameters describing the models such as number of bytes, type of model (neural network/decision tree, etc., required input features, also non-radio type of input such as GNSS, model weights for each combination of weak learners).

The characterizing information may also include an importance weight for each model. This could be implemented for example as a value between 0 and 1, wherein a model weight of 0.5 has 5 times more importance than a weight of 0.1. An example of such a weight is alpha in the boosting example algorithm of FIG. 6 discussed above.

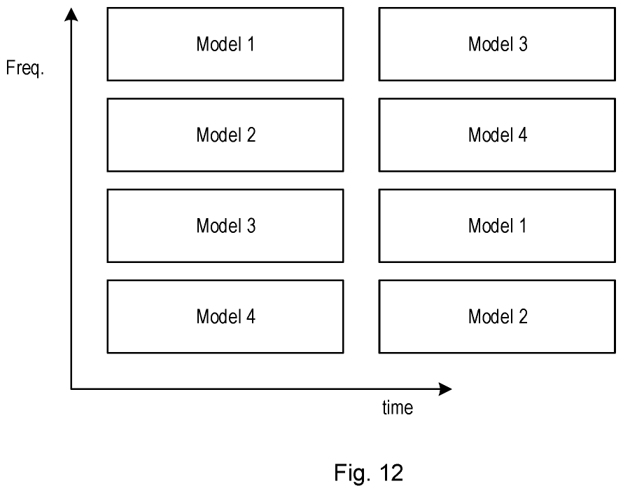

FIG. 12 illustrates an example time/frequency resource allocation for transmitting configuration information for the base ML models. In the example of FIG. 12, an ensemble prediction with four models is shown, and the RAN node has distributed the models in the time-frequency grid to improve diversity.

### Deciding Which Models to Receive (Step 220 of Method 200)

As discussed above, a wide range of criteria may be used by the wireless device to determine which of the base ML models described in the received characterizing information it should attempt to receive. Examples of such criteria include the indicated accuracy information and size, device specific model accuracy requirements for a certain RAN operation, device capabilities including memory, processing speed, battery status, etc., and UE behavior, including mobility, memory, and traffic characteristics.

### Selected Models and Usage for RAN Operation (Steps 240 and 250 of Method 200, and 140 and 150 of Method 100)

Following receipt of the configuration information for the base ML models, the device feeds back to the RAN node an indication of which models were correctly received and can be used by the device. This may be a simple number or index, or identification of the particular base ML models. The RAN node can then set a parameter related to the device indicated base ML models or index. For example, if a device has downloaded a model that can accurately predict a future radio signal quality, the RAN node can set link-adaptation parameters associated to the received forecasted value. Otherwise, the network, via the RAN node, can rely more on adaptive techniques such as outer-loop link adaptation. Alternatively, dual connectivity settings can be adjusted for Secondary Carrier Prediction, as discussed below.

There now follows a discussion of example use cases for methods of the present disclosure.

### Example 1: Beam Measurement Prediction

A wireless device can use an ensemble ML model to reduce its measurement related to beamforming. In New Radio, the network can request a device to measure on a set of CSI-RS beams. A stationary device typically experiences fewer variations in beam quality in comparison to a moving device. The stationary device can, therefore, save battery by reducing its beam measurement and using an ensemble ML model to predict beam strength instead of measuring it. This may involve for example measuring a subset of the beams and predicting the rest of the beams.

### Example 2: Secondary Carrier Prediction

In order to detect a node on another frequency using target carrier prediction, a device is required to perform signalling of source carrier information. A mobile device periodically transmits source carrier information to enable its serving macro node to handover the device to another node operating at a higher frequency. By using target carrier prediction, the device can avoid performing inter-frequency measurements, leading to energy savings at the device. However, frequent signalling of source carrier information that enables prediction of the secondary frequency can lead to an additional overhead and should thus be minimized. The risk of not performing frequent periodic signalling is missing an opportunity of doing an inter-frequency handover to a less-loaded cell on another carrier.

The device can instead use an ensemble ML model obtained according to examples of the present disclosure. The device uses source carrier information as input to the model, which then triggers an output indicating coverage on the second node. This reduces the need of frequent source carrier information signalling, while enabling the device to predict the coverage on the alternative frequency whenever its model input changes.

### Example 3: Signal Quality Drop Prediction

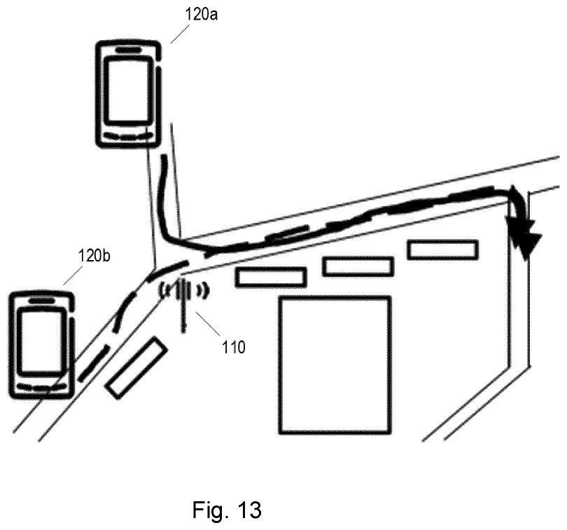

As described in WO 2020/226542, based on received device data from measurement reports, the network can learn for example what sequence of signal quality measurements (for example, RSRP) result in a large signal quality drop. With reference to FIG. 13, the network can learn that signal quality measurements associated with the paths illustrated are frequently followed by a signal quality drop as devices turn the corner, and their serving node is then hidden by buildings. This learning can be achieved for example by dividing periodic reported RSRP data into a training and prediction window. In the example illustrated in FIG. 13, two devices are turning around the same corner according to the location plot. If one device turns the corner first and experiences a large signal quality drop, then the signal quality drop of the second device can be mitigated by using learning from the first device's experience.

The learning can be performed by feeding time series RSRP data for t1, . . . , tn into a machine learning model (such as a neural network), and then learning the RSRP for tn+1,tn+2. After an ensemble of base ML models is obtained by a RAN node for this task, they can be provided to devices using methods disclosed herein. The devices can then predict future signal quality values, and the signal quality prediction can be used to avoid radio-link failure by performing any one or more of initiating inter-frequency handover, setting handover/reselection parameters, and/or changing device scheduler priority, for example scheduling the device when the expected signal quality is good

### Example 4: CSI Compression Using Autoencoders

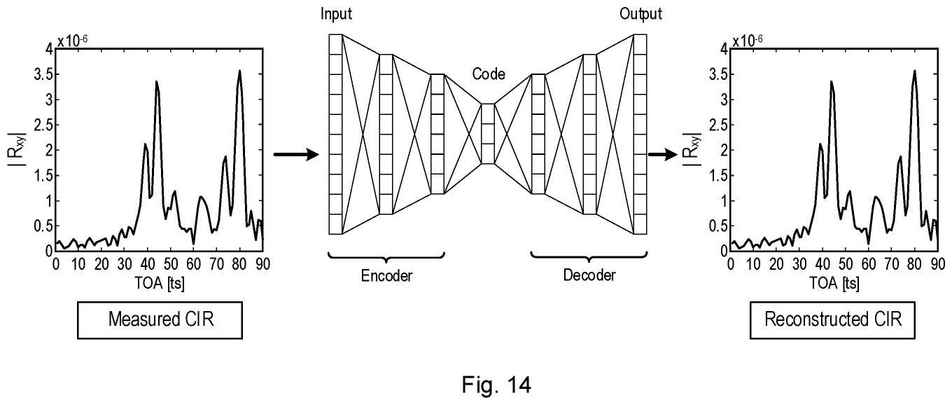

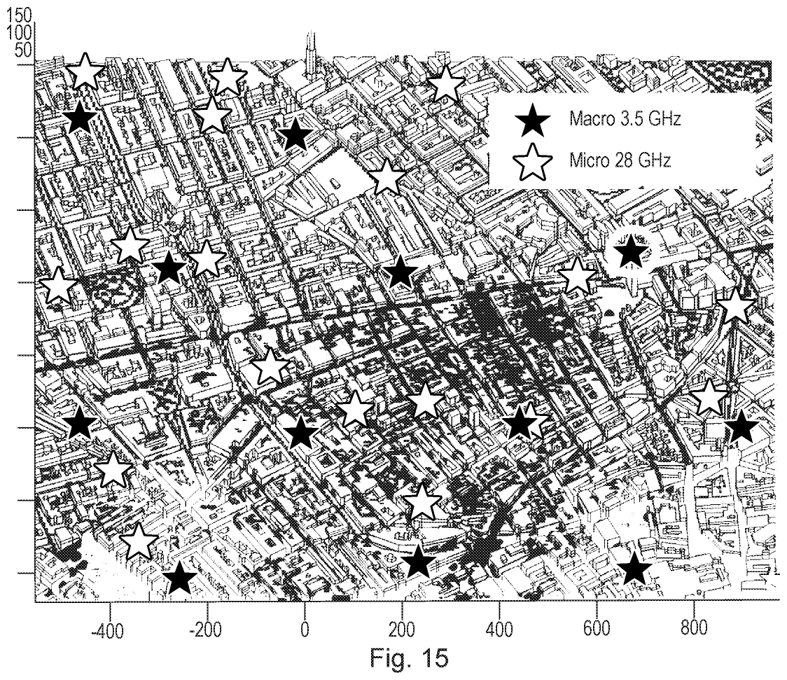

An autoencoder is a type of machine learning algorithm that may be used to learn efficient data representations, that is to concentrate data. Autoencoders are trained to take a set of input features and reduce the dimensionality of the input features, with minimal information loss. An autoencoder is divided into two parts, an encoding part or encoder and a decoding part or decoder. The encoder and decoder may comprise, for example, deep neural networks comprising layers of neurons. An encoder successfully encodes or compresses the data if the decoder is able to restore the original data stream with a tolerable loss of data. A compressed CSI using autoencoders has been proposed for enhanced beamforming. One example of an autoencoder comprising an encoder/decoder for CSI compression is illustrated in FIG. 14. The absolute values of the Channel Impulse Response (CIR) are compressed to a code, and the code is decoded to reconstruct the measured CIR. In a beamforming context, the UE reports the code to a RAN node, which then performs beamforming based on the decoded code (reconstructed CIR). In some examples, an ensemble of autoencoders may be provided to a device using methods according to examples of the present disclosure, so allowing for more efficient compression and decompression of the channels. Example use cases 2 and 4 discussed above are now explored in greater detail with reference to FIGS. 15 to 17.

### Secondary Carrier Prediction (SCP)

In the secondary carrier prediction use case, the radio strength on a secondary carrier frequency is predicted based on radio measurements on the source frequency. The device then only performs inter-frequency measurements when it has high probability of being in coverage of the secondary carrier cell. One example scenario is depicted in FIG. 15, in which devices served by the circled macro cell should be handed over to a micro cell on the 28 GHz carrier. This is modeled as a binary classification problem, where a classification of 1 or 0 indicates whether or not a device has coverage on any of the 28 GHz carrier micro cells. Some devices may not be in the vicinity of any micro cell and thus should be mainly placed in category 0 (no micro cell coverage).

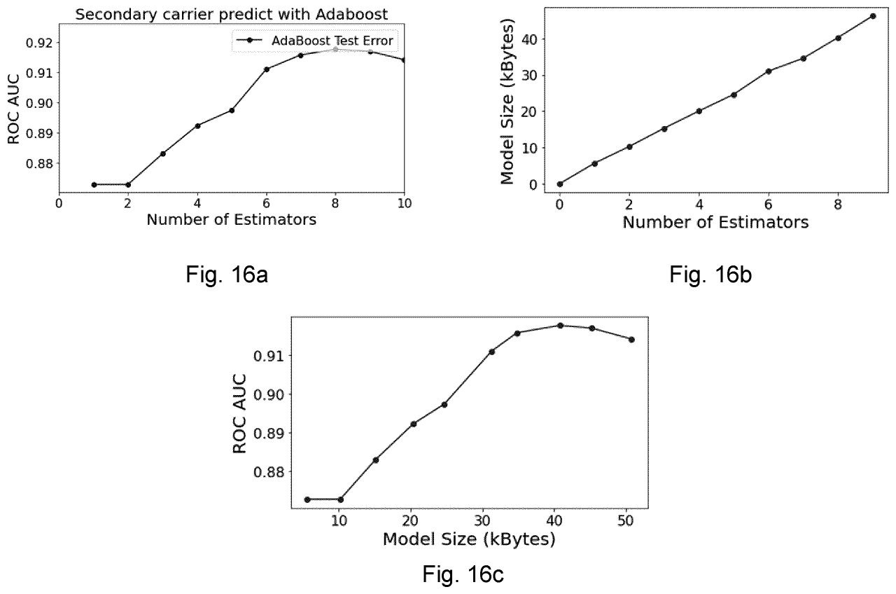

In the illustrated scenario, the 57 macro-cells on the 3.5 GHz frequency are transmitting 4-wide SSB beams, and the measured RSRP of the SSB beams at a wireless device device is used as the radiolocation of the wireless device. This results in 228 different measurements, each averaged over multiple seconds. In the present example implementation, these source carrier measurements are used as an input to train an AdaBoost (ensemble learning) ML algorithm with a varying number of decision trees. FIG. 16a illustrates how the performance of the ensemble model (measured as ROC-AUC) increases with the number of estimators (base ML models). The ROC-AUC can be related to the number of unnecessary inter-freq. measurements performed by the devices in H. Ryden, J. Berglund, M. Isaksson, R. Cöster and F. Gunnarsson, “Predicting strongest cell on secondary carrier using primary carrier data,” 2018 IEEE Wireless Communications and Networking Conference Workshops (WCNCW), 2018, pp. 137-142, doi: 10.1109/WCNCW.2018.8369000. FIG. 16b illustrates how ensemble model size increases with number of estimators, and FIG. 16c illustrates the relation between model performance and model size. By enabling individual devices to select how many estimators they wish to receive and use in connection with the SCP procedure, the individual devices can manage the tradeoff between ensemble model performance and model size according to their individual capabilities, requirements and circumstances. This personalization of the ensemble model is achieved according to examples of the present disclosure without the high signaling overhead associated with unicasting personalized models to individual devices.

In an implementation of the methods disclosed herein, having obtained the trained ensemble model of base ML models (step 110 of method 100), the RAN node may first select to broadcast or multicast characterizing information for 8 base ML models (step 120 of method 100), as the performance improvement with additional base ML models is not significant according to FIG. 16a. The RAN node transmits for the 8 estimators a description of the ROC-AUC values and the size for the varying number of estimators, with values according to FIGS. 16a to 16c. The RAN node then transmits configuration information for the estimators themselves (step 130 of method 100). It may be assumed for the purposes of the present example that two devices intend to perform dual connectivity with the 28 GHz if possible. A first device might require a high bitrate due to its QoS requirements. It may therefore choose to receive all 8 base ML models (step 230 of method 200) in order to accurately predict when a 28 GHz carrier is in predicted coverage. A second device with less stringent QoS requirements may choose to receive a smaller number of base ML models. The first device will have a model with higher recall in comparison to a second device, that may therefore miss out on some true positives (i.e., fail to predict having 28 GHz coverage).

The RAN node can, based on the device indicated ensemble of weak learners (steps 240 and 140 of methods 200 and 100), prepare device dual connectivity proactively for the device with an accurate model (step 150 of method 100) when it reports 28 GHz predicted coverage. The RAN node doesn't need to have the first device verify its predictions by inter-freq. measurements before preparing dual connectivity, owing to the accuracy of the ensemble model with 8 base ML models. The RAN node can directly send a Secondary gNB Addition Request to the appropriate Secondary Node (micro 28 GHZ). For the second device, the RAN node may require the device to verify its predictions with inter-freq. measurements before setting up dual connectivity.

### CSI Compression

CSI compression with autoencoders is a prevalent concept which uses the inherent representation and generation ability of autoencoders, reducing the number of bits required for CSI signaling.

Some channels are harder to compress than others. Using an ensemble of autoencoders provided to a device according to examples of the present disclosure allows for more efficient compression and decompression of the channels. The number of autoencoders in the ensemble can be scaled up or down depending on the capability in UE, desired performance, and the size of MIMO configuration.

When using an ensemble of autoencoders, the channels could be compressed as proposed in the steps below:
a. One or more stronger channels with relatively similar power in a MIMO configuration are compressed by an encoder of an autoencoder.
b. The remaining channels are compressed using the encoder in another instance of the autoencoder.
c. Step b. is repeated if more than one group of channels with similar power are found.
d. All the compressed channels are decompressed separately then joined to create the reconstructed channel at the base station.

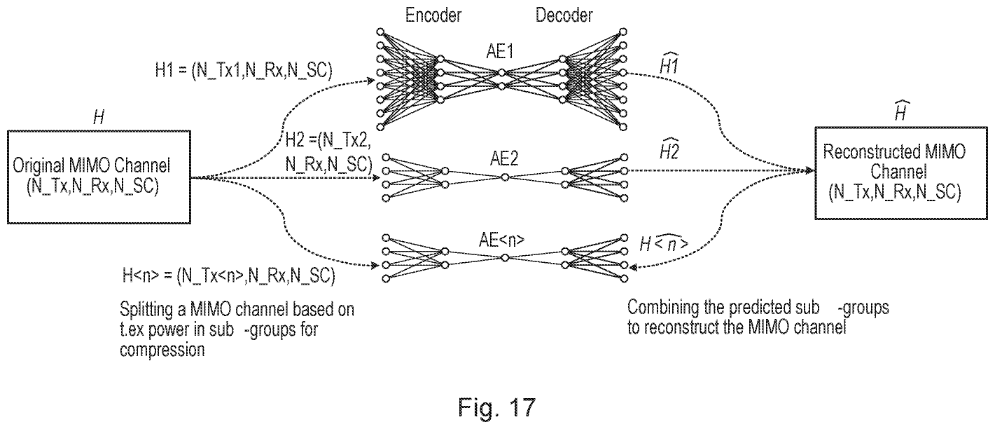

FIG. 17 is an example illustration of channel compression using an ensemble of encoders.

### Examples of RAN Operations Executed With ML Models

It will be appreciated that an ensemble ML model can be provided to a device in accordance with examples of the present disclosure for use in connection with a wide range of RAN operations. In addition to those listed above in the example use cases, examples of RAN operations in connection with which example methods of the present disclosure may be carried out include:
Power control in Uplink (UL) transmission
Link adaptation in UL transmission, such as selection of modulation and coding scheme
Estimation of channel quality or other performance metrics, such as:
   radio channel estimation in UL and Downlink (DL),
   channel quality indicator (CQI) estimation/selection,
   signal to noise estimation for UL and DL,
   signal to noise and interference estimation,
   reference signal received power (RSRP) estimation,
   reference signal received quality (RSRQ) estimation, etc.
Information compression for UL transmission
Coverage estimation for secondary carrier
Estimation of signal quality/strength degradation
   Beam-level
   Cell-level
Mobility related operations, such as cell reselection and handover trigger
Energy saving operations
Positioning using ML methods, for example a model that translates radio measurements into a geographical location.

Examples of the present disclosure thus provide methods according to which multiple base ML models may be transmitted, for example via broadcast or multicast, to a plurality of wireless devices. The base ML models are for use in connection with a RAN operation, have been trained using an ensemble based training method, such as stacking or boosting, and can be combined by the individual devices in order to improve model accuracy. Each device can select one or more of the transmitted base ML models, for example based on its QoS requirements, user behavior (traffic, mobility) and available processing capabilities. In this manner, flexibility is offered for devices to make ensemble-based predictions, balancing model performance against resource cost and capability in accordance with their own individual circumstances and needs, and without incurring the signaling overhead associated with unicasting tailored models to each device. Each device can assess the trade-off between the overhead in downloading and running a particular combination of base ML models, or having a model at all, against the benefits offered by running such an ensemble.

It will be appreciated that a device can select one or more models based on its capabilities and use case requirements. The overhead in processing associated with receiving a large model might outweigh the gain in using the model for a given radio operation. Examples of the present disclosure afford the flexibility for individual devices to select the best alternative for their circumstances. For example, a device might select an advanced radio signal quality forecast model if RLF would be highly costly for that device. Another device might select an advanced SCP model if it requires the best possible signal quality in order to ensure acceptable quality of experience in an application that it is currently running. Additionally, RAN nodes are offered increased flexibility in model signaling, as individual signaling of specific models to specific devices for specific use cases is avoided, with model size controlled by the devices themselves through the selection of how many base ML models of the ensemble they wish to receive. Signaling is also reduced in that examples of the present disclosure do not require devices to inform the network of their capabilities; the network, in the form of RAN nodes, transmits base ML models of the ensemble, and the devices decide which models to receive according to their own capabilities and circumstances.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or numbered embodiments. The word “comprising” does not exclude the presence of elements or steps other than those listed in a claim or embodiment, “a” or “an” does not exclude a plurality, and a single processor or other unit may fulfil the functions of several units recited in the claims or numbered embodiments. Any reference signs in the claims or numbered embodiments shall not be construed so as to limit their scope.

1. A method for managing a plurality of wireless devices that are operable to connect to a communication network, the communication network comprising a Radio Access Network, RAN, the method, performed by a RAN node of the communication network, the method comprising:
obtaining a plurality of base Machine Learning, ML models, each base ML model being operable to provide an output on the basis of which at least one RAN operation performed by a wireless device may be configured, the plurality of base ML models having been trained using an ensemble training method;
transmitting characterising information for individual models of the plurality of base ML models over the RAN;
transmitting configuration information for the plurality of base ML models over the RAN;
receiving, from at least one wireless device, an indication of which one or more of the plurality of base ML models the wireless device will be using as an ensemble ML model in connection with a RAN operation performed by the wireless device; and
setting a value of at least one configuration parameter associated with the RAN operation performed by the wireless device based on the received indication.

2. The method as claimed in claim 1, wherein configuration information for a base ML model comprises at least one of a representation of the base ML model or an update to the base ML model.

3. The method as claimed in claim 2, wherein transmitting configuration information for the plurality of base ML models over the RAN comprises sending at least one of a broadcast transmission or a multicast transmission of the configuration information.

4. (canceled)

5. The method as claimed in claim 1, wherein obtaining a plurality of base ML models, wherein each base ML model is operable to provide an output on the basis of which at least one RAN operation performed by a wireless device may be configured, and wherein the plurality of base ML models has been trained using an ensemble training method, comprises at least one of:
training the plurality of base ML models using an ensemble training method; or
receiving the plurality of base ML models from a logical entity responsible for training the plurality of base ML models.

6. The method as claimed in claim 1, further comprising:
following transmission of the characterising information, receiving, from the plurality of wireless devices, an indication for each of the plurality of wireless devices of which of the plurality of base ML models each wireless device will attempt to receive;
identifying any of the plurality of base ML models that are not included in an indication for any of the plurality of wireless devices; and
omitting from the transmission of configuration information for the plurality of base ML models, configuration information for any identified base ML model.

7. The method as claimed in claim 1, wherein, for a wireless device, the indication of which one or more of the plurality of base ML models the wireless device will be using as an ensemble ML model in connection with a RAN operation performed by the wireless device comprises an indication of the one or more base ML models that the wireless device was able to correctly configure using the transmitted configuration information.

8. The method as claimed in claim 1, wherein the at least one configuration parameter associated with the RAN operation performed by the wireless device comprises one or both of:
a reporting criterion for reporting of information relating to an output of the ensemble ML model executed by the wireless device; and
a parameter relating to configuration, on the basis of an output of the ensemble ML model, of the RAN operation performed by the wireless device.

9. The method as claimed in claim 1, further comprising:
receiving, from at least one wireless device, information based on an output of the ensemble ML model executed by the wireless device in connection with a RAN operation performed by the wireless device.

10. (canceled)

11. (canceled)

12. A method for managing a wireless device that is operable to connect to a communication network, the communication network comprises a Radio Access Network, RAN, the method, performed by the wireless device, comprising:
receiving, in a transmission from a RAN node of the communication network, characterising information for a plurality of base Machine Learning, ML models, each base ML model being operable to provide an output on the basis of which at least one RAN operation performed by the wireless device may be configured, the plurality of base ML models having been trained using an ensemble training method;
determining which one or more of the plurality of base ML models to receive from the RAN node;
receiving, in a transmission from the RAN node of the communication network, configuration information for the determined base ML models;
transmitting to the RAN node an indication of which one or more of the plurality of base ML models the wireless device will be using as an ensemble ML model in connection with a RAN operation performed by the wireless device;
executing the indicated base ML models as an ensemble ML model in accordance with the received configuration information; and
performing a RAN operation configured on the basis of an output of the executed ensemble ML model.

13. The method as claimed in claim 12, wherein the indication of which one or more of the plurality of base ML models the wireless device will be using as an ensemble ML model in connection with a RAN operation performed by the wireless device comprises an indication of the one or more base ML models that the wireless device is able to correctly configure using the transmitted configuration information.

14. The method as claimed in claim 12, wherein determining which one or more of the plurality of base ML models to receive from the RAN node comprises selecting base ML models from among the plurality of base ML models according to at least one of:
the RAN operation to be configured on the basis of an output of the executed ensemble ML model;
a Quality of Service requirement for the wireless device;
a behaviour of the wireless device;
processing capabilities of the wireless device; and
energy information for the wireless device.

15. The method as claimed in claim 12, wherein configuration information for a base ML model comprises at least one of a representation of the base ML model or an update to the base ML model.

16. The method as claimed in claim 12, wherein receiving, in a transmission from the RAN node of the communication network, configuration information for the determined base ML models comprises receiving at least one of a broadcast transmission or a multicast transmission of the configuration information.

17. The method as claimed in claim 12, wherein characterising information for a base ML model comprises at least one of:
a description of the base ML model;
a performance measure of the base ML model; and
information about how to combine the base ML model with other base ML models to form an ensemble ML model.

18. The method as claimed in claim 12, further comprising:
transmitting, to the RAN node, an indication of the determined base ML models.

19. The method as claimed in claim 12, wherein performing a RAN operation configured on the basis of an output of the executed ensemble ML model comprises receiving from the RAN node a value of at least one configuration parameter associated with the RAN operation.

20. The method as claimed in claim 12, wherein performing a RAN operation configured on the basis of an output of the executed ensemble ML model comprises at least one of:
reporting information relating to an output of the ensemble ML model executed by the wireless device in accordance with a value of a configuration parameter received from the RAN node;
using an output of the ensemble ML model in performing the RAN operation;
performing the RAN operation in accordance with a value of a configuration parameter set on the basis of an output of the ensemble ML model; and
performing the RAN operation in accordance with a value of a configuration parameter received from the RAN node.

21. The method as claimed in claim 12, further comprising:
transmitting to the RAN node information based on an output of the ensemble ML model executed by the wireless device in connection with the RAN operation.

22. (canceled)

23. (canceled) 24 A Radio Access Network, RAN, node of a communication network comprising a RAN, the RAN node being for managing a plurality of wireless devices that are operable to connect to a communication network, the RAN node comprising processing circuitry configured to cause the RAN node to:
obtain a plurality of base Machine Learning, ML models, each base ML model being operable to provide an output on the basis of which at least one RAN operation performed by a wireless device may be configured, the plurality of base ML models having been trained using an ensemble training method;
transmit characterising information for the plurality of base ML models over the RAN;
transmit configuration information for the plurality of base ML models over the RAN;
receive, from at least one wireless device, an indication of which one or more of the plurality of base ML models the wireless device will be using as an ensemble ML model in connection with a RAN operation performed by the wireless device; and
set a value of at least one configuration parameter associated with the RAN operation performed by the wireless device based on the received indication.

25. (canceled)

26. A wireless device that is operable to connect to a communication network, wherein the communication network comprises comprising a Radio Access Network, RAN, the wireless device comprising processing circuitry configured to cause the wireless device to:
receive, in a transmission from a RAN node of the communication network, characterising information for a plurality of base Machine Learning, ML models, each base ML model being operable to provide an output on the basis of which at least one RAN operation performed by the wireless device may be configured, the plurality of base ML models having been trained using an ensemble training method;
determine which one or more of the plurality of base ML models to receive from the RAN node;
receive, in a transmission from the RAN node of the communication network, configuration information for the determined base ML models;
transmit to the RAN node an indication of which one or more of the plurality of base ML models the wireless device will be using as an ensemble ML model in connection with a RAN operation performed by the wireless device;
execute the indicated base ML models as an ensemble ML model in accordance with the received configuration information; and
perform a RAN operation configured on the basis of an output of the executed ensemble ML model.

27. (canceled)
